(19) United States
(12) Patent Application Publication
(10) Pub. No.: US 2025/0103317 A1
(43) Pub. Date: Mar. 27, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Yoshikazu UGAI, Kanagawa (JP)

(73) Assignee: FUJIFILM Business Innovation Corp., Tokyo (JP)

(21) Appl. No.: 18/583,901

(22) Filed: Feb. 22, 2024

(30) Foreign Application Priority Data
Sep. 25, 2023 (JP) 2023-161519

(51) Int. Cl. G06F 8/65; G06F 3/12

(52) U.S. Cl. CPC G06F 8/65; G06F 3/1203; G06F 3/123; G06F 3/1288

(57) ABSTRACT

An information processing system including a physical apparatus, a service apparatus that performs a service for updating an application program installed on the physical apparatus, and a virtual apparatus that is a virtual apparatus of the physical apparatus and that stores metadata including information indicating a version number of the application program installed on the physical apparatus, includes one or plural processors configured to cause the service apparatus to, in a case of transmitting the application program after the update to the physical apparatus specified as an apparatus as an update target for the application program by referring to the metadata, transmit request information for requesting transmission of the application program to the physical apparatus, to the virtual apparatus, cause the virtual apparatus to, in a case where the request information is received from the service apparatus, transmit the application program after the update or instruction information for providing an instruction to receive the application program from the service apparatus, to the corresponding physical apparatus, and cause the physical apparatus to, in a case where the application program or the instruction information is received from the virtual apparatus, execute processing of updating the application program.

### CROSS-REFERENCE TO RELATED APPLICATIONS

This application is based on and claims priority under 35 USC 119 from Japanese Patent Application No. 2023-161519 filed Sep. 25, 2023.

### BACKGROUND

### (i) Technical Field

The present disclosure relates to an information processing system, a non-transitory computer readable medium storing a program, and an information processing method.

### (ii) Related Art

JP2021-163983A discloses a Web server for improving operability of settings in transmitting scanned image data to a cloud service.

The Web server is a Web server accessible to the cloud service and includes a provision unit that provides a setting screen for performing a setting related to image data as a transmission target to a client apparatus, a transmission unit that transmits the image data as the transmission target to the cloud service in accordance with the setting related to the image data as the transmission target received from a user of the client apparatus on the setting screen, and a storage unit that stores the setting related to the image data as the transmission target received from the user on the setting screen in association with a type of the image data as the transmission target and with information about the user, in which the provision unit, in the case of providing a setting screen for performing a setting related to image data as a new transmission target, provides the setting screen for performing the setting related to the image data as the new transmission target in a state where a setting stored in association with image data of the same type as the image data as the new transmission target and with information about the same user as a user performing the setting related to the image data as the new transmission target is reflected among settings stored in the storage unit.

### SUMMARY

In recent years, a technology for virtually implementing functions, settings, and the like of an actual device as a shadow on a cloud server has been widely used. Here, the term “device” means various apparatuses, and the term “shadow” means a virtual apparatus that is virtually implemented as the apparatus.

In the digital shadow technology, since the device and the shadow synchronize with each other through communication, a user can manage the device via the shadow of the cloud server by performing the following operations.
At least one of an operation or a setting for the device is performed by performing at least one of an operation or a setting on the shadow.
At least one of the operation or the setting for the device is performed to be reflected on the shadow.

Meanwhile, an application program that is installed in advance or additionally installed in the actual device (hereinafter, referred to as a “physical apparatus”) is relatively frequently updated. In the case of performing the update, the application program for the physical apparatus needs to be updated after accessing all of a wide range of commercially available physical apparatuses to specify the physical apparatus to be updated. Thus, an issue arises in that the update cannot be performed at once. This issue may occur not only in updating the application program but also in updating setting information of the application program. Hereinafter, the expression “update of the application program” will be used including this aspect.

Aspects of non-limiting embodiments of the present disclosure relate to an information processing system, a non-transitory computer readable medium storing a program, and an information processing method that can update an application program on physical apparatuses at once without accessing all possible physical apparatuses as a target.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a physical apparatus, a service apparatus that performs a service for updating an application program installed on the physical apparatus, and a virtual apparatus that is a virtual apparatus of the physical apparatus and that stores metadata including information indicating a version number of the application program installed on the physical apparatus, the information processing system including one or a plurality of processors configured to cause the service apparatus to, in a case of transmitting the application program after the update to the physical apparatus specified as an apparatus as an update target for the application program by referring to the metadata, transmit request information for requesting transmission of the application program to the physical apparatus, to the virtual apparatus, cause the virtual apparatus to, in a case where the request information is received from the service apparatus, transmit the application program after the update or instruction information for providing an instruction to receive the application program from the service apparatus, to the corresponding physical apparatus, and cause the physical apparatus to, in a case where the application program or the instruction information is received from the virtual apparatus, execute processing of updating the application program.

### BRIEF DESCRIPTION OF THE DRAWINGS

Exemplary embodiment(s) of the present invention will be described in detail based on the following figures, wherein:

FIG. 1 is a block diagram illustrating an example of a configuration of an information processing system according to an exemplary embodiment of the present disclosure;

FIG. 2 is a block diagram illustrating an example of a configuration of an electrical system of a first cloud server according to the exemplary embodiment of the present disclosure;

FIG. 3 is a block diagram illustrating an example of a configuration of an electrical system of a second cloud server according to the exemplary embodiment of the present disclosure;

FIG. 4 is a block diagram illustrating an example of a configuration of an electrical system of an image forming apparatus according to the exemplary embodiment of the present disclosure;

FIG. 5 is a block diagram illustrating an example of a functional configuration of the information processing system according to the exemplary embodiment of the present disclosure;

FIG. 6 is a schematic diagram illustrating an example of a configuration of a metadata database according to the exemplary embodiment of the present disclosure;

FIG. 7 is a flowchart illustrating an example of first information processing according to a first exemplary embodiment of the present disclosure;

FIG. 8 is a flowchart illustrating an example of second information processing according to the first exemplary embodiment of the present disclosure;

FIG. 9 is a flowchart illustrating an example of third information processing according to the first exemplary embodiment of the present disclosure;

FIG. 10 is a schematic diagram for describing an action of the information processing system according to the exemplary embodiment of the present disclosure;

FIG. 11 is a flowchart illustrating an example of the first information processing according to a second exemplary embodiment of the present disclosure;

FIG. 12 is a flowchart illustrating an example of the second information processing according to the second exemplary embodiment of the present disclosure;

FIG. 13 is a flowchart illustrating an example of the third information processing according to the second exemplary embodiment of the present disclosure;

FIG. 14 is a flowchart illustrating an example of the first information processing according to a third exemplary embodiment of the present disclosure;

FIG. 15 is a flowchart illustrating an example of the second information processing according to the third exemplary embodiment of the present disclosure; and

FIG. 16 is a flowchart illustrating an example of the third information processing according to the third exemplary embodiment of the present disclosure.

### DETAILED DESCRIPTION

Hereinafter, exemplary embodiments of the present disclosure will be described in detail with reference to the drawings. In the present exemplary embodiment, a case where the technology of the present disclosure is applied to an information processing system that provides a service called a digital shadow, described above, for storing various types of data stored in a physical apparatus connected through a communication line such as the Internet in synchronization with the physical apparatus will be described. Here, the physical apparatus includes various apparatuses such as an image forming apparatus and a personal computer. In addition, the various types of data include various types of data such as setting information, history information, state information, configuration information, and an address table. Hereinafter, a case where an image forming apparatus is applied as the physical apparatus will be described.

### First Exemplary Embodiment

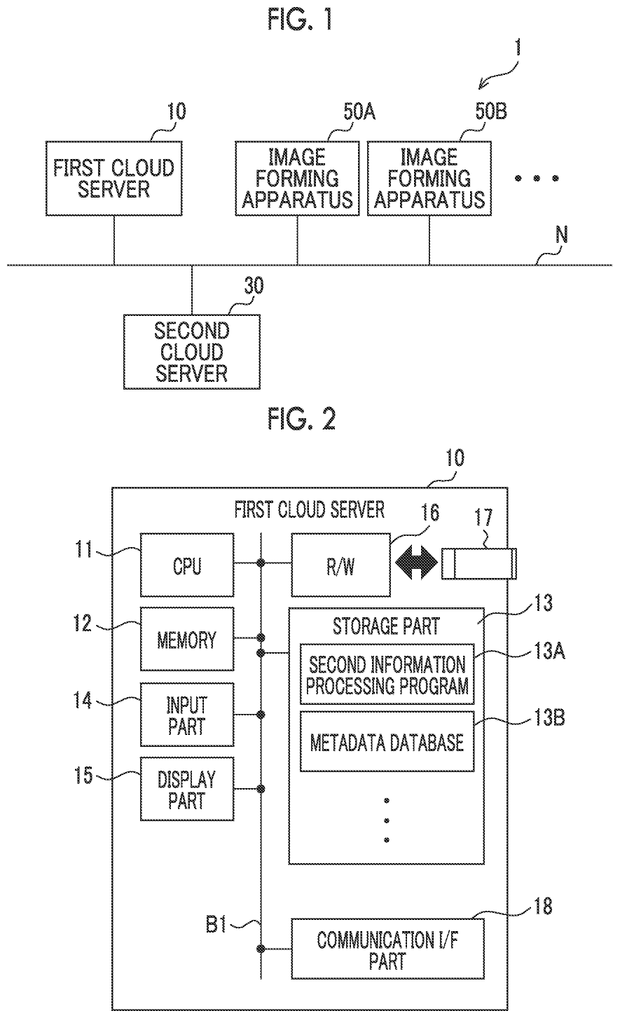

First, a configuration of an information processing system 1 according to the present exemplary embodiment will be described with reference to FIG. 1. FIG. 1 is a block diagram illustrating an example of the configuration of the information processing system 1 according to the present exemplary embodiment.

As illustrated in FIG. 1, the information processing system 1 according to the present exemplary embodiment includes a first cloud server 10 and a second cloud server 30 configured as cloud servers, and a plurality of image forming apparatuses 50A, 50B, . . . . Hereinafter, the image forming apparatuses 50A, 50B, . . . will be simply collectively referred to as an “image forming apparatus 50” in a case where the image forming apparatuses 50A, 50B, . . . are described without distinction.

Examples of the first cloud server 10 and the second cloud server 30 include information processing apparatuses such as a personal computer and a server computer. In addition, in the present exemplary embodiment, a digital multifunction peripheral having an image printing function, an image reading function, an image transmission function, and the like is applied as the image forming apparatus 50. However, the present disclosure is not limited to this form and may include a form of applying other image forming apparatuses such as an image forming apparatus having only the image printing function and an image forming apparatus having only the image printing function and only the image reading function as the image forming apparatus 50.

The first cloud server 10, the second cloud server 30, and the image forming apparatus 50 are connected via a network N, and these apparatuses can communicate with each other via the network N.

In the present exemplary embodiment, a combination of a public communication line such as the Internet and a telephone line network and a company communication line such as a local area network (LAN) and a wide area network (WAN) is applied as the network N. However, the present disclosure is not limited to this form. For example, the present disclosure may include a form of applying only any one of the public communication line and the company communication line as the network N. In addition, in the present exemplary embodiment, wired and wireless communication lines are applied as the network N. However, the present disclosure is not limited to this form and may include a form of applying only any one of the wireless communication line and the wired communication line.

Next, a configuration of the first cloud server 10 according to the present exemplary embodiment will be described with reference to FIG. 2. FIG. 2 is a block diagram illustrating an example of a configuration of an electrical system of the first cloud server 10 according to the present exemplary embodiment.

As illustrated in FIG. 2, the first cloud server 10 according to the present exemplary embodiment includes a central processing unit (CPU) 11 as a processor, a memory 12 as a temporary storage area, a non-volatile storage part 13, an input part 14 such as a keyboard and a mouse, a display part 15 such as a liquid crystal display, a medium read and write device (R/W) 16, and a communication interface (I/F) part 18. The CPU 11, the memory 12, the storage part 13, the input part 14, the display part 15, the medium read and write device 16, and the communication I/F part 18 are connected to each other via a bus B1. The medium read and write device 16 reads out information written on a recording medium 17 and writes information on the recording medium 17.

The storage part 13 according to the present exemplary embodiment is implemented by a hard disk drive (HDD), a solid state drive (SSD), a flash memory, or the like. The storage part 13 as a storage medium stores a second information processing program 13A. The second information processing program 13A is stored (installed) in the storage part 13 by connecting the recording medium 17 on which the program 13A is written to the medium read and write device 16 and reading out the program 13A from the recording medium 17 via the medium read and write device 16. The CPU 11 appropriately reads out and loads the second information processing program 13A into the memory 12 from the storage part 13 and sequentially executes processes of the second information processing program 13A.

In addition, the storage part 13 stores a metadata database 13B. Details of the metadata database 13B will be described later.

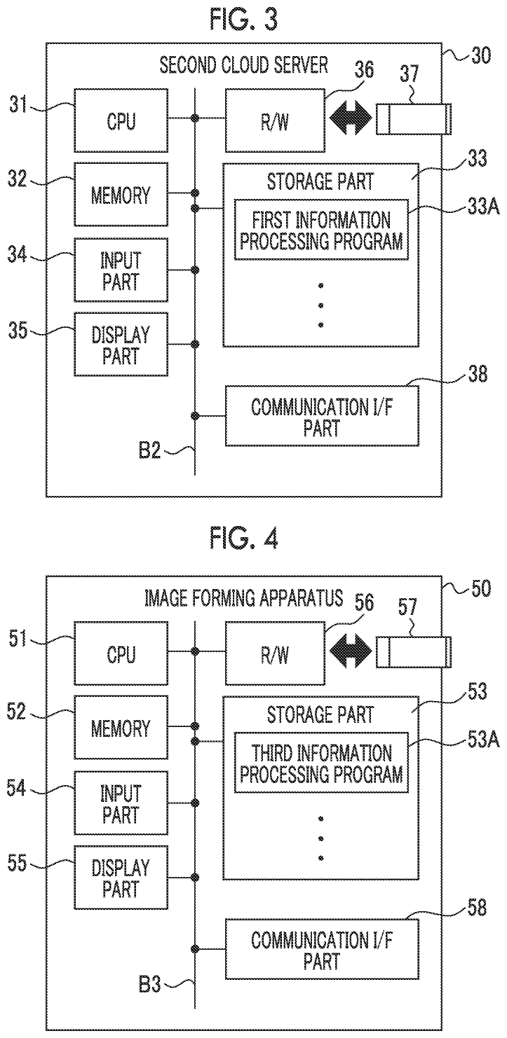

Next, a configuration of the second cloud server 30 according to the present exemplary embodiment will be described with reference to FIG. 3. FIG. 3 is a block diagram illustrating an example of a configuration of an electrical system of the second cloud server 30 according to the present exemplary embodiment.

As illustrated in FIG. 3, the second cloud server 30 according to the present exemplary embodiment includes a CPU 31 as a processor, a memory 32 as a temporary storage area, a non-volatile storage part 33, an input part 34 such as a keyboard and a mouse, a display part 35 such as a liquid crystal display, a medium read and write device (R/W) 36, and a communication I/F part 38. The CPU 31, the memory 32, the storage part 33, the input part 34, the display part 35, the medium read and write device 36, and the communication I/F part 38 are connected to each other via a bus B2. The medium read and write device 36 reads out information written on a recording medium 37 and writes information on the recording medium 37.

The storage part 33 according to the present exemplary embodiment is implemented by an HDD, an SSD, a flash memory, or the like. The storage part 33 as a storage medium stores a first information processing program 33A. The first information processing program 33A is stored (installed) in the storage part 33 by connecting the recording medium 37 on which the program 33A is written to the medium read and write device 36 and reading out the program 33A from the recording medium 37 via the medium read and write device 36. The CPU 31 appropriately reads out and loads the first information processing program 33A into the memory 32 from the storage part 33 and sequentially executes processes of the first information processing program 33A.

Next, a configuration of the image forming apparatus 50 according to the present exemplary embodiment will be described with reference to FIG. 4. FIG. 4 is a block diagram illustrating an example of a configuration of an electrical system of the image forming apparatus 50 according to the present exemplary embodiment.

As illustrated in FIG. 4, the image forming apparatus 50 according to the present exemplary embodiment includes a CPU 51 as a processor, a memory 52 as a temporary storage area, a non-volatile storage part 53, an input part 54 such as various switches, a display part 55 such as a liquid crystal display, a medium read and write device (R/W) 56, and a communication I/F part 58. The CPU 51, the memory 52, the storage part 53, the input part 54, the display part 55, the medium read and write device 56, and the communication I/F part 58 are connected to each other via a bus B3. The medium read and write device 56 reads out information written on a recording medium 57 and writes information on the recording medium 57.

The storage part 53 according to the present exemplary embodiment is implemented by an HDD, an SSD, a flash memory, or the like. The storage part 53 as a storage medium stores a third information processing program 53A. The third information processing program 53A is stored (installed) in the storage part 53 by connecting the recording medium 57 on which the program 53A is written to the medium read and write device 56 and reading out the program 53A from the recording medium 57 via the medium read and write device 56. The CPU 51 appropriately reads out and loads the third information processing program 53A into the memory 52 from the storage part 53 and sequentially executes processes of the third information processing program 53A.

In the information processing system 1 according to the present exemplary embodiment, each image forming apparatus 50 is the physical apparatus, and a plurality of virtual apparatuses that are virtual apparatuses of corresponding physical apparatuses, respectively, are constructed in the first cloud server 10. For each virtual apparatus, the first cloud server 10 stores metadata including information indicating a version number of an application program installed on the corresponding physical apparatus. In the information processing system 1 according to the present exemplary embodiment, the second cloud server 30 is a service apparatus that performs a service for updating the application program installed on each physical apparatus.

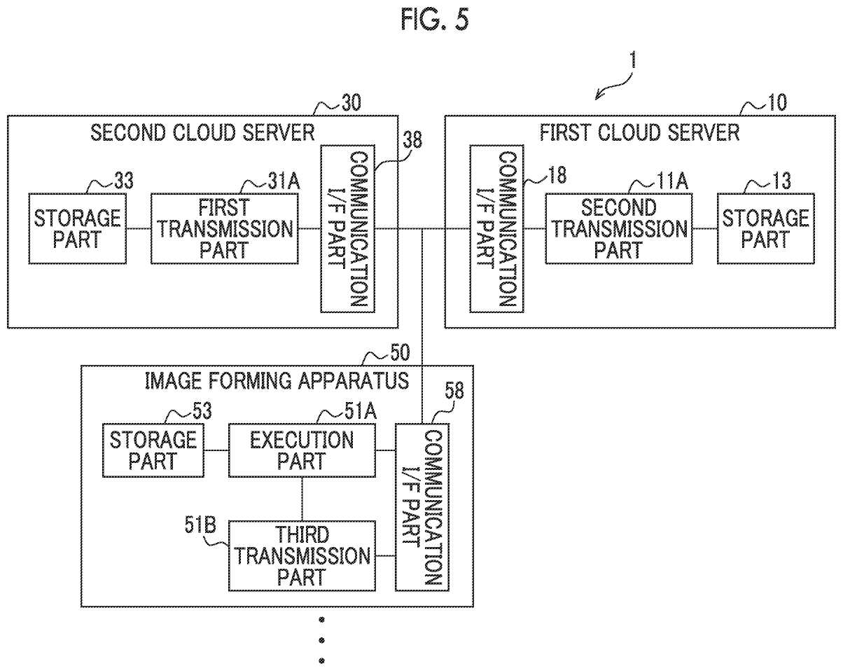

Next, a functional configuration of the information processing system 1 according to the present exemplary embodiment will be described with reference to FIG. 5. FIG. 5 is a block diagram illustrating an example of the functional configuration of the information processing system 1 according to the present exemplary embodiment.

As illustrated in FIG. 5, the second cloud server 30 according to the present exemplary embodiment includes a first transmission part 31A, the first cloud server 10 includes a second transmission part 11A, and the image forming apparatus 50 includes an execution part 51A and a third transmission part 51B. The CPU 31 of the second cloud server 30 functions as the first transmission part 31A by executing the first information processing program 33A. In addition, the CPU 11 of the first cloud server 10 functions as the second transmission part 11A by executing the second information processing program 13A. Furthermore, the CPU 51 of the image forming apparatus 50 functions as the execution part 51A and as the third transmission part 51B by executing the third information processing program 53A.

The first transmission part 31A of the second cloud server 30 according to the present exemplary embodiment specifies the image forming apparatus 50 as an update target for the application program by referring to the metadata stored in the first cloud server 10. The first transmission part 31A, in the case of transmitting the application program after the update to the specified image forming apparatus 50, transmits request information for requesting transmission of the application program to the image forming apparatus 50, to the virtual apparatus, that is, the first cloud server 10.

Meanwhile, the second transmission part 11A of the first cloud server 10 according to the present exemplary embodiment, in a case where the request information is received from the second cloud server 30, transmits the application program after the update to the corresponding image forming apparatus 50.

The execution part 51A of the image forming apparatus 50 according to the present exemplary embodiment, in a case where the application program is received from the first cloud server 10, executes processing of updating the application program (in the present exemplary embodiment, processing of overwriting the installed application program with the received application program).

Here, after the processing of updating the application program is executed, the third transmission part 51B of the image forming apparatus 50 according to the present exemplary embodiment transmits result information indicating a result of the update to the virtual apparatus. In the present exemplary embodiment, success and failure information indicating whether or not the update of the application program has succeeded is applied as the result information. However, the present disclosure is not limited to the present exemplary embodiment. For example, the present disclosure may include a form of, in a case where the update has failed, applying cause information indicating a cause of the failure as the result information in addition to the success and failure information.

The second cloud server 30 according to the present exemplary embodiment is an apparatus on a cloud platform. Accordingly, the second cloud server 30 can handle more image forming apparatuses 50 than the second cloud server 30 that is an on-premises apparatus.

In addition, the application program according to the present exemplary embodiment is an additional application program. Accordingly, the information processing system 1 according to the present exemplary embodiment can handle the additional application program.

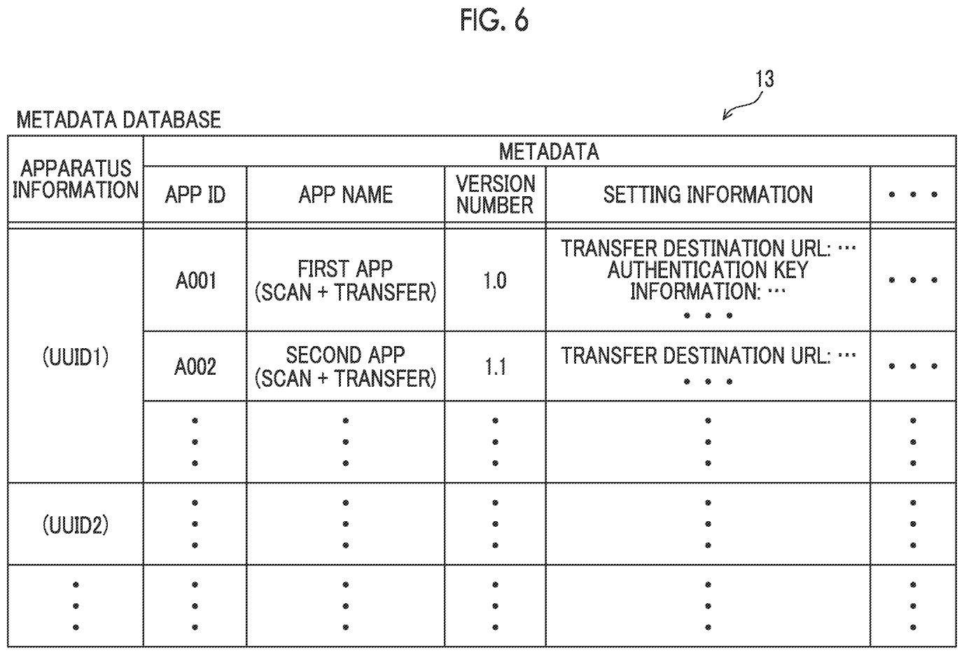

Next, the metadata database 13B according to the present exemplary embodiment will be described with reference to FIG. 6. FIG. 6 is a schematic diagram illustrating an example of a configuration of the metadata database 13B according to the present exemplary embodiment.

The metadata database 13B according to the present exemplary embodiment is a database in which the metadata of the image forming apparatuses 50 corresponding to the virtual apparatuses constructed in the first cloud server 10 is registered. For example, as illustrated in FIG. 6, apparatus information and each information of the metadata are stored in association with each other.

The apparatus information is information that is set in advance to be different for each image forming apparatus 50 in order to individually identify each image forming apparatus 50 targeted by the information processing system 1. In the present exemplary embodiment, a universally unique identifier (UUID) of the corresponding image forming apparatus 50 is applied as the apparatus information. However, the present disclosure is not limited to the present exemplary embodiment. For example, the present disclosure may include a form of applying a combination of a model and a serial number of the corresponding image forming apparatus 50 as the apparatus information.

In addition, the metadata is information indicating the metadata of the corresponding image forming apparatus 50 and includes an app identification (ID), an app name, a version number, the setting information, and the like in the present exemplary embodiment.

The app ID is information that is set in advance to be different for each application program in order to individually identify each application program installed on the corresponding image forming apparatus 50. In addition, the app name is information indicating a name of the corresponding application program, and the version number is information indicating the version number of the corresponding application program. The setting information is information that is set with respect to the corresponding application program.

In the example illustrated in FIG. 6, the application program named a first app executes processing of reading (scanning) an image using the image reading function of the image forming apparatus 50 on which the application program is installed and transferring obtained image information to an apparatus that is set in advance. Accordingly, the setting information in this case includes, for example, as illustrated in FIG. 6, information indicating a transfer destination of the image information and information indicating a key for authenticating a user. In the present exemplary embodiment, a uniform resource locator (URL) of the transfer destination is applied as the information indicating the transfer destination. However, the present disclosure is not limited to this form and may include a form of applying information indicating other transfer destinations such as a UUID of the apparatus at the transfer destination, a combination of a model and a serial number of the apparatus at the transfer destination, and a mail address of an electronic mail as the information indicating the transfer destination.

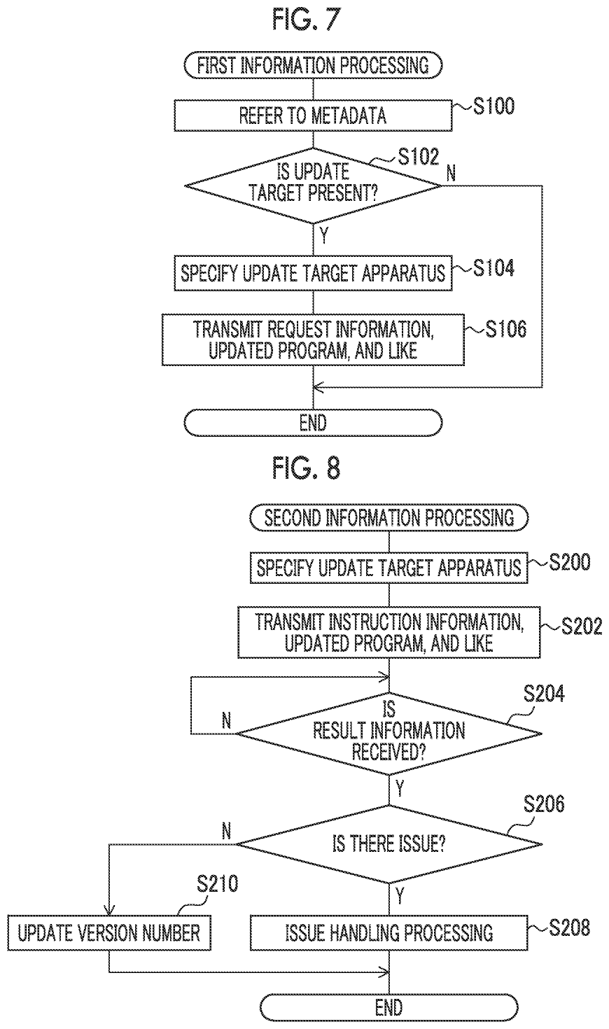

Next, an action of the information processing system 1 according to the present exemplary embodiment will be described with reference to FIGS. 7 to 10.

First, an action of the second cloud server 30 in the case of executing first information processing will be described with reference to FIG. 7. FIG. 7 is a flowchart illustrating an example of the first information processing according to the present exemplary embodiment.

In the information processing system 1 according to the present exemplary embodiment, for example, the first information processing illustrated in FIG. 7 is executed by executing the first information processing program 33A via the CPU 31 of the second cloud server 30 at a timing at which the second cloud server 30 receives an update instruction to update the application program with an updated version from a service center provided by a manufacturer or the like of the image forming apparatus 50 targeted by the information processing system 1. Hereinafter, a case where the metadata database 13B is already constructed will be described in order to avoid complication. In addition, hereinafter, a case where the corresponding application program after the update (hereinafter, referred to as an “updated program”), name information indicating the name of the application program, and version number information indicating the version number of the application program are also transmitted to the second cloud server 30 from the service center together with the update instruction will be described.

In step S100 in FIG. 7, the CPU 31 refers to the entire metadata of the metadata database 13B of the first cloud server 10.

In step S102, the CPU 31 determines whether or not the application program that is indicated by the name information received together with the update instruction and that has an older version number than the version number indicated by the received version number information is present in the metadata to which the CPU 31 has referred to. In a case where a negative determination is made as a result of the determination, the CPU 31 determines that the application program as an update target is not present and finishes the first information processing. Meanwhile, in a case where a positive determination is made as a result of the determination, the CPU 31 determines that the application program (hereinafter, referred to as an “update target program”) as the update target is present and transitions to step S104.

In step S104, the CPU 31 specifies the image forming apparatus 50 (hereinafter, referred to as an “update target apparatus”) on which the update target program is installed from the apparatus information corresponding to the update target program.

In step S106, the CPU 31 transmits the request information for requesting transmission of the updated program to the corresponding update target apparatus, to the first cloud server 10. At this point, the CPU 31 also transmits the name information, information indicating the update target apparatus (in the present exemplary embodiment, the apparatus information of the update target apparatus (hereinafter, referred to as “update target apparatus information”)), the version number information, and the updated program to the first cloud server 10 in addition to the request information and then finishes the first information processing.

Next, an action of the first cloud server 10 in the case of executing second information processing will be described with reference to FIG. 8. FIG. 8 is a flowchart illustrating an example of the second information processing according to the present exemplary embodiment.

In the information processing system 1 according to the present exemplary embodiment, for example, the second information processing illustrated in FIG. 8 is executed by executing the second information processing program 13A via the CPU 11 of the first cloud server 10 at a timing at which the request information is received from the second cloud server 30. Here, a case where only one update target apparatus is present will be described in order to avoid complication.

In step S200 in FIG. 8, the CPU 11 specifies the update target apparatus indicated by the update target apparatus information received from the second cloud server 30 together with the request information.

In step S202, the CPU 11 transmits instruction information for providing an instruction to update the update target program indicated by the name information received from the second cloud server 30 together with the request information, to the specified update target apparatus together with the name information and with the updated program received from the second cloud server 30.

The update target apparatus, in a case where the instruction information is received, tries to update the update target program with the received updated program and transmits the result information indicating a result of the update to the first cloud server 10.

Therefore, in step S204, the CPU 11 waits until the result information is received. In step S206, the CPU 11 determines whether or not the received result information indicates that there is an issue (in the present exemplary embodiment, the update has failed) and, in a case where a positive determination is made, transitions to step S208.

In step S208, the CPU 11 executes issue handling processing that is set in advance for addressing the issue and then finishes the second information processing. In the present exemplary embodiment, processing of transmitting the updated program again to the update target apparatus and updating the update target program again with the transmitted updated program on the update target apparatus is applied as the issue handling processing. However, the present disclosure is not limited to the present exemplary embodiment. For example, the present disclosure may include a form of applying processing of stopping the update of the update target program and transmitting information indicating occurrence of an issue to the service center as the issue handling processing.

Meanwhile, in a case where a negative determination is made in step S206, the CPU 11 determines that there is no particular issue and transitions to step S210. In step S210, the CPU 11 updates information indicating the version number of the update target program in the metadata database 13B with the version number information received from the second cloud server 30 and then finishes the second information processing.

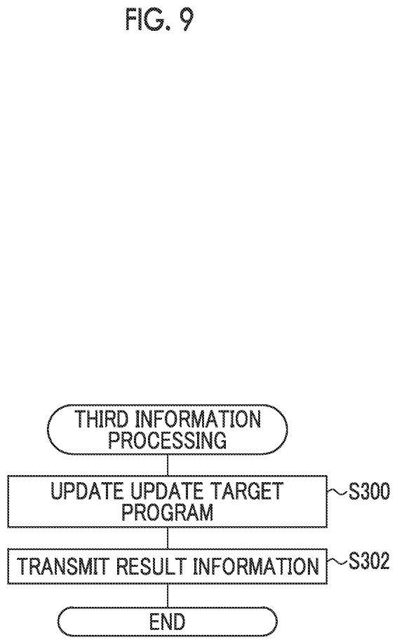

Next, an action of the image forming apparatus 50 in the case of executing third information processing will be described with reference to FIG. 9. FIG. 9 is a flowchart illustrating an example of the third information processing according to the present exemplary embodiment.

In the information processing system 1 according to the present exemplary embodiment, for example, the third information processing illustrated in FIG. 9 is executed by executing the third information processing program 53A via the CPU 51 of the image forming apparatus 50 at a timing at which the instruction information is received from the first cloud server 10.

In step S300 in FIG. 9, the CPU 51 executes processing of updating (in the present exemplary embodiment, processing of overwriting) the update target program indicated by the name information received from the first cloud server 10 together with the instruction information, with the received updated program.

In step S302, the CPU 51 transmits the success and failure information to the first cloud server 10 as the result information and then finishes the third information processing.

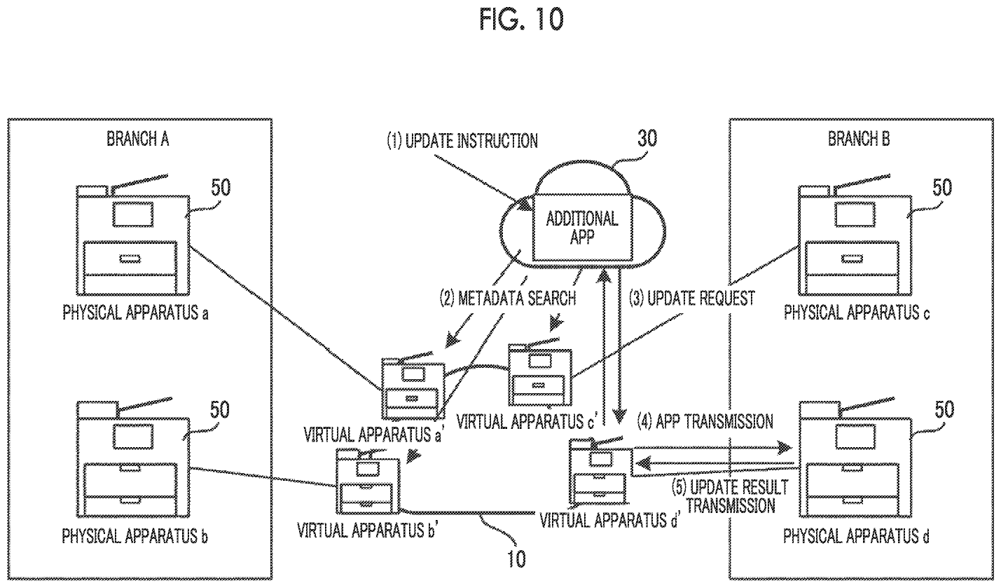

FIG. 10 is a schematic diagram for describing the action of the information processing system 1 according to the present exemplary embodiment.

For example, as illustrated in FIG. 10, in the information processing system 1 according to the present exemplary embodiment, the second cloud server 30, in a case where the update instruction for the application program (in the present exemplary embodiment, the additional application program) is received from the service center, searches the metadata stored in the first cloud server 10 and specifies the image forming apparatus 50 that is the physical apparatus as the update target for the application program. The second cloud server 30 requests the first cloud server 10 to update the target application program for the specified image forming apparatus 50 by transmitting the request information to the first cloud server 10.

The first cloud server 10, in a case where the request information is received from the second cloud server 30, instructs the corresponding image forming apparatus 50 to update the application program by transmitting the instruction information to the corresponding image forming apparatus 50 together with the application program after the update.

Meanwhile, the image forming apparatus 50, in a case where the instruction information is received, tries to update the corresponding application program with the application program received together with the instruction information and transmits the result information indicating the result to the first cloud server 10.

The first cloud server 10, in a case where the result information is received and the result information indicates that there is an issue (in the present exemplary embodiment, the update has failed), executes processing for addressing the issue.

### Second Exemplary Embodiment

In the present exemplary embodiment, an example of a form of transmitting information (in the present exemplary embodiment, a URL) indicating a storage destination of the updated program to the physical apparatus instead of transmitting the updated program to the physical apparatus, and receiving the updated program from the second cloud server 30 in a pulled manner via the physical apparatus will be described. A configuration of the information processing system 1 according to the present exemplary embodiment is approximately the same as the configuration of the information processing system 1 according to the first exemplary embodiment and thus, will not be described here.

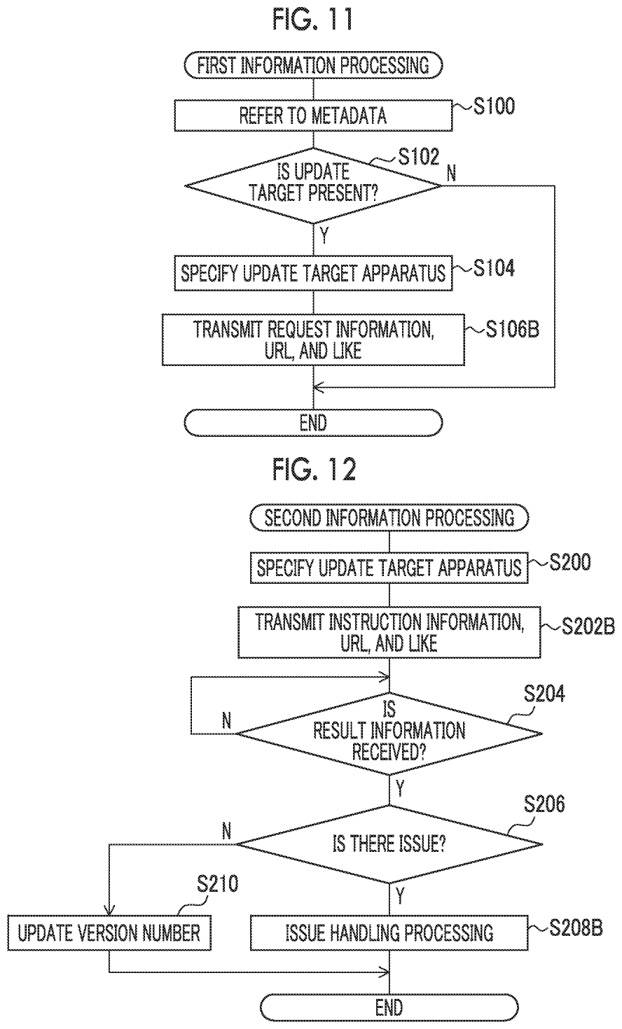

Hereinafter, an action of the information processing system 1 according to the present exemplary embodiment will be described with reference to FIGS. 11 to 13.

First, an action of the second cloud server 30 in the case of executing the first information processing will be described with reference to FIG. 11. FIG. 11 is a flowchart illustrating an example of the first information processing according to the present exemplary embodiment. Steps in which processing identical to the first information processing according to the first exemplary embodiment illustrated in FIG. 7 is performed will be designated by step numbers identical to FIG. 7 and will not be described. Hereinafter, a case where the URL indicating the storage destination of the updated program, the name information, and the version number information are also transmitted to the second cloud server 30 from the service center together with the update instruction will be described.

In step S106B, the CPU 31 transmits the request information for requesting transmission of the updated program to the corresponding update target apparatus, to the first cloud server 10. At this point, the CPU 31 also transmits the name information, the update target apparatus information, and the version number information to the first cloud server 10 in addition to the request information, transmits the URL indicating the storage destination of the updated program to the first cloud server 10 instead of the updated program, and then finishes the first information processing.

Next, an action of the first cloud server 10 in the case of executing the second information processing will be described with reference to FIG. 12. FIG. 12 is a flowchart illustrating an example of the second information processing according to the present exemplary embodiment. Steps in which processing identical to the second information processing according to the first exemplary embodiment illustrated in FIG. 8 is performed will be designated by step numbers identical to FIG. 8 and will not be described.

In step S202B, the CPU 11 transmits the instruction information for providing the instruction to update the update target program indicated by the name information received from the second cloud server 30 together with the request information, to the update target apparatus specified in step S200 together with the name information and with the URL received from the second cloud server 30.

The update target apparatus, in a case where the instruction information is received, tries to update the update target program with the updated program stored at the storage destination indicated by the received URL and transmits the result information indicating the result of the update to the first cloud server 10.

Then, in step S208B, the CPU 11 executes the issue handling processing that is set in advance for addressing the issue indicated by the result information received from the update target apparatus and then finishes the second information processing. In the present exemplary embodiment, processing of transmitting the URL again to the update target apparatus again and updating the update target program again with the updated program stored at the storage destination indicated by the transmitted URL is applied as the issue handling processing. However, the present disclosure is not limited to the present exemplary embodiment. For example, the present disclosure may include a form of applying processing of stopping the update of the update target program and transmitting information indicating occurrence of an issue to the service center as the issue handling processing.

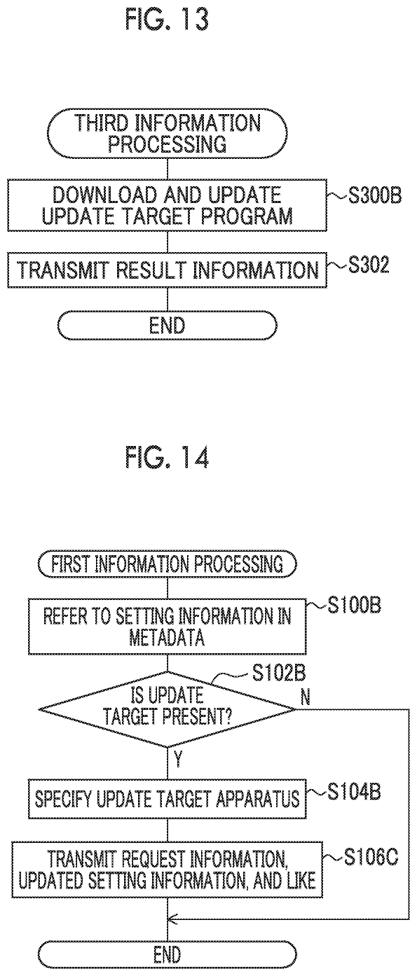

Next, an action of the image forming apparatus 50 in the case of executing the third information processing will be described with reference to FIG. 13. FIG. 13 is a flowchart illustrating an example of the third information processing according to the present exemplary embodiment. Steps in which processing identical to the third information processing according to the first exemplary embodiment illustrated in FIG. 9 is performed will be designated by step numbers identical to FIG. 9 and will not be described.

In step S300B, the CPU 51 downloads the updated program using the URL received from the first cloud server 10 together with the instruction information. The CPU 51 executes processing of updating (in the present exemplary embodiment, processing of overwriting) the update target program indicated by the name information received from the first cloud server 10 together with the instruction information, with the downloaded updated program.

### Third Exemplary Embodiment

In the present exemplary embodiment, an example of a form of updating the setting information of the application program instead of updating the application program will be described. A configuration of the information processing system 1 according to the present exemplary embodiment is approximately the same as the configuration of the information processing system 1 according to the first exemplary embodiment and thus, will not be described here. Examples of a situation in which the setting information is updated include a case where the key for authenticating the user needs to be changed because of a change in an authentication policy on a cloud side, and a case where the transfer destination of the image information obtained using the image reading function of the image forming apparatus 50 needs to be changed.

Hereinafter, an action of the information processing system 1 according to the present exemplary embodiment will be described with reference to FIGS. 14 to 16.

First, an action of the second cloud server 30 in the case of executing the first information processing will be described with reference to FIG. 14. FIG. 14 is a flowchart illustrating an example of the first information processing according to the present exemplary embodiment. Steps in which processing identical to the first information processing according to the first exemplary embodiment illustrated in FIG. 7 is performed will be designated by step numbers identical to FIG. 7 and will not be described.

In the information processing system 1 according to the present exemplary embodiment, for example, the first information processing illustrated in FIG. 14 is executed by executing the first information processing program 33A via the CPU 31 of the second cloud server 30 at a timing at which the second cloud server 30 receives the update instruction to update the setting information of the application program from the service center. Hereinafter, a case where the corresponding setting information after the update (hereinafter, referred to as “updated setting information”) and the name information indicating the name of the application program are also transmitted to the second cloud server 30 from the service center together with the update instruction will be described.

In step S100B, the CPU 31 refers to the setting information in the metadata of the metadata database 13B of the first cloud server 10.

In step S102B, the CPU 31 determines whether or not the setting information different from the setting information indicated by the received updated setting information is present for the application program indicated by the name information received together with the update instruction in the setting information to which the CPU 31 has referred to. In a case where a negative determination is made as a result of the determination, the CPU 31 determines that the setting information as an update target is not present and finishes the first information processing. Meanwhile, in a case where a positive determination is made as a result of the determination, the CPU 31 determines that the setting information (hereinafter, referred to as “update target setting information”) as the update target is present and transitions to step S104B.

In step S104B, the CPU 31 specifies the image forming apparatus 50 (hereinafter, referred to as the “update target apparatus”) on which the update target setting information is set from the apparatus information corresponding to the update target setting information.

In step S106C, the CPU 31 transmits the request information for requesting transmission of the updated setting information to the corresponding update target apparatus, to the first cloud server 10. At this point, the CPU 31 also transmits the name information, the update target apparatus information, and the updated setting information to the first cloud server 10 in addition to the request information and then finishes the first information processing.

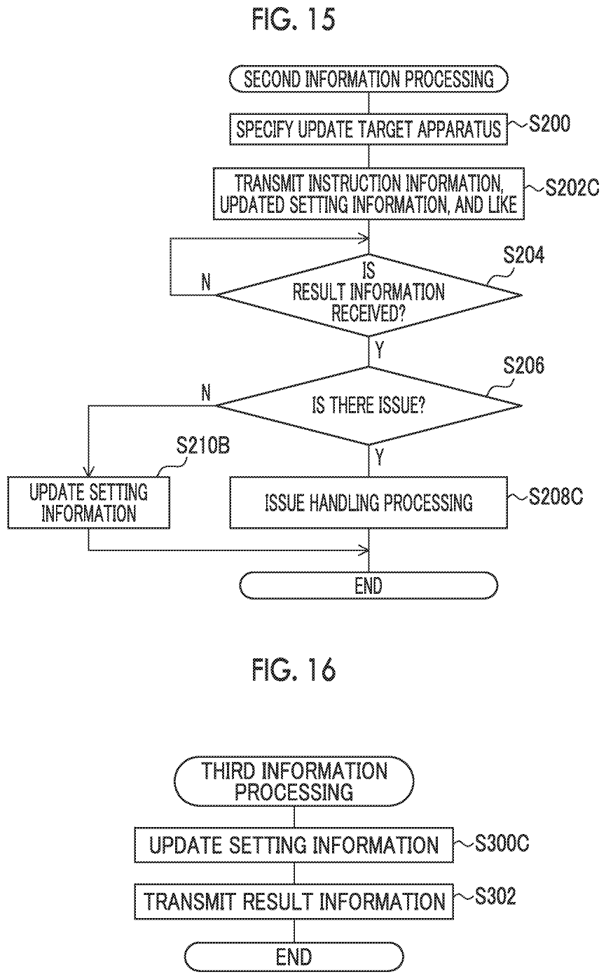

Next, an action of the first cloud server 10 in the case of executing the second information processing will be described with reference to FIG. 15. FIG. 15 is a flowchart illustrating an example of the second information processing according to the present exemplary embodiment. Steps in which processing identical to the second information processing according to the first exemplary embodiment illustrated in FIG. 8 is performed will be designated by step numbers identical to FIG. 8 and will not be described.

In step S202C, the CPU 11 transmits the instruction information for providing an instruction to update the setting information of the update target program indicated by the name information received from the second cloud server 30 together with the request information, to the update target apparatus specified in step S200 together with the name information and with the updated setting information received from the second cloud server 30.

The update target apparatus, in a case where the instruction information is received, tries to update the setting information of the update target program with the received updated setting information and transmits the result information indicating a result of the update to the first cloud server 10.

Then, in step S208C, the CPU 11 executes the issue handling processing that is set in advance for addressing the issue indicated by the result information received from the update target apparatus and then finishes the second information processing. In the present exemplary embodiment, processing of transmitting the updated setting information again to the update target apparatus and updating the setting information of the update target program again with the transmitted updated setting information on the update target apparatus is applied as the issue handling processing. However, the present disclosure is not limited to the present exemplary embodiment. For example, the present disclosure may include a form of applying processing of stopping the update of the setting information of the update target program and transmitting information indicating occurrence of an issue to the service center as the issue handling processing.

In step S210B, the CPU 11 updates the update target setting information of the update target program in the metadata database 13B with the updated setting information received from the second cloud server 30 and then finishes the second information processing.

Next, an action of the image forming apparatus 50 in the case of executing the third information processing will be described with reference to FIG. 16. FIG. 16 is a flowchart illustrating an example of the third information processing according to the present exemplary embodiment. Steps in which processing identical to the third information processing according to the first exemplary embodiment illustrated in FIG. 9 is performed will be designated by step numbers identical to FIG. 9 and will not be described.

In step S300C, the CPU 51 executes processing of updating (in the present exemplary embodiment, processing of overwriting) the setting information of the update target program indicated by the name information received together with the instruction information, with the updated setting information received from the first cloud server 10 together with the instruction information.

While a case where the image forming apparatus 50 is applied as the physical apparatus according to the exemplary embodiment of the present disclosure has been described in each exemplary embodiment, the present disclosure is not limited to the exemplary embodiments. For example, the present disclosure may include a form of applying other apparatuses such as a personal computer and a portable information terminal to which the digital shadow technology can be applied as the physical apparatus according to the exemplary embodiment of the present disclosure.

While the exemplary embodiments have been described above, the technical scope of the present invention is not limited to the scope described in the exemplary embodiments. The exemplary embodiments can be changed or improved in various manners without departing from the gist of the invention, and the changed or improved exemplary embodiments also fall within the technical scope of the present invention.

In addition, each exemplary embodiment does not limit the invention according to the claims, and not all combinations of features described in the exemplary embodiments are necessary for addressing the issues in the invention. The exemplary embodiments include various stages of the invention, and various inventions are derived depending on a combination of a plurality of disclosed configuration requirements. Even in a case where several configuration requirements are removed from all configuration requirements illustrated in the exemplary embodiments, the configuration in which several configuration requirements are removed may be derived as an invention as long as the configuration is effective.

In addition, for example, while the term “system” in each exemplary embodiment is described as being configured with a plurality of apparatuses, the system may be configured with a single apparatus.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

Furthermore, while a case of implementing various types of processing with a software configuration using a computer by executing a program has been described in each exemplary embodiment, the present invention is not limited to the exemplary embodiments. For example, the present invention may include a form of implementing various types of processing with a hardware configuration or with a combination of a hardware configuration and a software configuration.

In addition, the configurations of the first cloud server 10, the second cloud server 30, and the image forming apparatus 50 described in each exemplary embodiment are examples. Unnecessary parts may be removed or new parts may be added without departing from the gist of the present invention.

In addition, flows of various types of processing described in each exemplary embodiment are also examples. Unnecessary steps may be removed, new steps may be added, or a processing order may be changed without departing from the gist of the present invention.

### Supplementary Note

(((1)))

An information processing system including a physical apparatus, a service apparatus that performs a service for updating an application program installed on the physical apparatus, and a virtual apparatus that is a virtual apparatus of the physical apparatus and that stores metadata including information indicating a version number of the application program installed on the physical apparatus, the information processing system comprising:
one or a plurality of processors configured to:
   cause the service apparatus to, in a case of transmitting the application program after the update to the physical apparatus specified as an apparatus as an update target for the application program by referring to the metadata, transmit request information for requesting transmission of the application program to the physical apparatus, to the virtual apparatus;
   cause the virtual apparatus to, in a case where the request information is received from the service apparatus, transmit the application program after the update or instruction information for providing an instruction to receive the application program from the service apparatus, to the corresponding physical apparatus; and
   cause the physical apparatus to, in a case where the application program or the instruction information is received from the virtual apparatus, execute processing of updating the application program.
      (((2)))

The information processing system according to (((1)),
wherein the physical apparatus, after executing the processing of updating the application program, transmits result information indicating a result of the update to the virtual apparatus.
   (((3)))

The information processing system according to (((1))) or (((2))),
wherein the physical apparatus, in a case where the instruction information is received from the virtual apparatus, receives the application program from the service apparatus in a pulled manner.
   (((4)))

The information processing system according to (((3))),
wherein the instruction information includes information indicating a storage destination of the application program, and
the physical apparatus, in a case where the instruction information is received from the virtual apparatus, receives the application program from the service apparatus using the information indicating the storage destination.
   (((5)))

The information processing system according to any one of (((1))) to (((4))),
wherein the service apparatus is an apparatus on a cloud platform.
   (((6)))

The information processing system according to any one of (((1))) to (((5))),
wherein the update of the application program is an update of setting information of the application program.
   (((7)))

The information processing system according to (((6))),
wherein the physical apparatus is an image forming apparatus having an image reading function, and
information as an update target in the setting information includes information indicating a transfer destination of image information obtained using the image reading function of the image forming apparatus.
   (((8)))

The information processing system according to any one of (((1))) to (((7))),
wherein the application program is an additional application program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system including a physical apparatus, a service apparatus that performs a service for updating an application program installed on the physical apparatus, and a virtual apparatus that is a virtual apparatus of the physical apparatus and that stores metadata including information indicating a version number of the application program installed on the physical apparatus, the information processing system comprising:
one or a plurality of processors configured to:
cause the service apparatus to, in a case of transmitting the application program after the update to the physical apparatus specified as an apparatus as an update target for the application program by referring to the metadata, transmit request information for requesting transmission of the application program to the physical apparatus, to the virtual apparatus;
cause the virtual apparatus to, in a case where the request information is received from the service apparatus, transmit the application program after the update or instruction information for providing an instruction to receive the application program from the service apparatus, to the corresponding physical apparatus; and
cause the physical apparatus to, in a case where the application program or the instruction information is received from the virtual apparatus, execute processing of updating the application program.

2. The information processing system according to claim 1,
wherein the physical apparatus, after executing the processing of updating the application program, transmits result information indicating a result of the update to the virtual apparatus.

3. The information processing system according to claim 1,
wherein the physical apparatus, in a case where the instruction information is received from the virtual apparatus, receives the application program from the service apparatus in a pulled manner.

4. The information processing system according to claim 2,
wherein the physical apparatus, in a case where the instruction information is received from the virtual apparatus, receives the application program from the service apparatus in a pulled manner.

5. The information processing system according to claim 3,
wherein the instruction information includes information indicating a storage destination of the application program, and
the physical apparatus, in a case where the instruction information is received from the virtual apparatus, receives the application program from the service apparatus using the information indicating the storage destination.

6. The information processing system according to claim 4,
wherein the instruction information includes information indicating a storage destination of the application program, and
the physical apparatus, in a case where the instruction information is received from the virtual apparatus, receives the application program from the service apparatus using the information indicating the storage destination.

7. The information processing system according to claim 1,
wherein the service apparatus is an apparatus on a cloud platform.

8. The information processing system according to claim 2,
wherein the service apparatus is an apparatus on a cloud platform.

9. The information processing system according to claim 1,
wherein the update of the application program is an update of setting information of the application program.

10. The information processing system according to claim 2,
wherein the update of the application program is an update of setting information of the application program.

11. The information processing system according to claim 9,
wherein the physical apparatus is an image forming apparatus having an image reading function, and
information as an update target in the setting information includes information indicating a transfer destination of image information obtained using the image reading function of the image forming apparatus.

12. The information processing system according to claim 10,
wherein the physical apparatus is an image forming apparatus having an image reading function, and
information as an update target in the setting information includes information indicating a transfer destination of image information obtained using the image reading function of the image forming apparatus.

13. The information processing system according to claim 1,
wherein the application program is an additional application program.

14. The information processing system according to claim 2,
wherein the application program is an additional application program.

15. A non-transitory computer readable medium storing a program executed by a service apparatus in an information processing system including a physical apparatus, the service apparatus that performs a service for updating an application program installed on the physical apparatus, and a virtual apparatus that is a virtual apparatus of the physical apparatus and that stores metadata including information indicating a version number of the application program installed on the physical apparatus, the program causing a computer to execute a process comprising:
transmitting, in a case of transmitting the application program after the update to the physical apparatus specified as an apparatus as an update target for the application program by referring to the metadata, request information for requesting transmission of the application program to the physical apparatus, to the virtual apparatus.

16. An information processing method executed by a service apparatus in an information processing system including a physical apparatus, the service apparatus that performs a service for updating an application program installed on the physical apparatus, and a virtual apparatus that is a virtual apparatus of the physical apparatus and that stores metadata including information indicating a version number of the application program installed on the physical apparatus, the information processing method comprising:
transmitting, in a case of transmitting the application program after the update to the physical apparatus specified as an apparatus as an update target for the application program by referring to the metadata, request information for requesting transmission of the application program to the physical apparatus, to the virtual apparatus.
